(19) United States
(12) Patent Application Publication
(10) Pub. No.: US 2026/0301229 A1
(43) Pub. Date: Oct. 1, 2026

(54) COMPRESSION AND DECOMPRESSION TECHNIQUES FOR DENSE GEOMETRY FORMAT TRIANGLE MESHES

(71) Applicant: Advanced Micro Devices, Inc., Santa Clara, CA (US)

(72) Inventor: Joshua David Barczak, Santa Clara, CA (US)

(73) Assignee: Advanced Micro Devices, Inc., Santa Clara, CA (US)

(21) Appl. No.: 19/094,161

(22) Filed: Mar. 28, 2025

(51) Int. Cl. G06T 9/00

(52) U.S. Cl. CPC G06T 9/001

(57) ABSTRACT

In some compression formats, individual items of compressed data have a variable size such that it is not straightforward to be able to determine where a particular item of compressed data is. One example of such a compression format represents a mesh of triangles as a set of compression blocks, where each block can have a different number of triangles. A technique is provided herein to perform a lookup that involves dividing the triangles in the set of compression blocks into fixed-size groups, each having corresponding metadata. The metadata includes location information for the first triangle of the group and a mask that indicates, for each triangle, whether that triangle is at the end of a compression block. Using this information, a decompressor performs bookkeeping operations to calculate which compressed block a triangle is in and which slot in that compressed block stores the information for that triangle.

### BACKGROUND

Graphics rendering involves processing a high amount of geometry. Compression helps reduce the amount of data required at the expense of extra processing.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example;

FIG. 4 illustrates an example of a compression scheme;

FIG. 5 illustrates a decompression system according to an example;

FIG. 6 illustrates information included in metadata for a fixed-size triangle group;

FIG. 7 is a flow diagram of a method for obtaining the block index and local triangle index based on the metadata and the input global triangle index, according to an example; and

FIG. 8 illustrates an example technique for obtaining a compressed block index and position in the compressed block based on group metadata.

### DETAILED DESCRIPTION

Rendering 3D geometry involves processing a very large amount of geometry. Compression techniques can be used to decrease the amount of data required for such geometry overall. A particular compression format for geometry is dense geometry format, in which geometries are represented in highly compacted format. In particular, metadata describes the connectivity between triangles. The compacted format represents a set of geometry (e.g., a compressed mesh) as a set of one or more compression blocks. Data for a variable number of triangles is included in each compression block.

One important operation in decompressing compressed data includes being able to access an arbitrary triangle within a set of compression blocks. In an example, each set includes information for a number of triangles, and each such triangle has an index that is unique within the set. It is often desirable to obtain information for a particular triangle, given the unique index of that triangle. Obtaining such information is not straightforward, however, as the triangles may be represented by different amounts of data. Thus the addressing function that calculates the address of the triangle based on the index is not necessarily straightforward. For example, it is not straightforward to be able to determine which compression block a triangle is in or which triangle in that compression block represents the desired triangle.

Techniques are provided herein for performing such a lookup. In particular, the technique involves dividing the triangles in the set of compression blocks into fixed-size groups. For each group, a set of metadata is stored. This metadata includes information for each such fixed-size group. The information includes information for the first triangle of each such group. This information indicates which compression block that triangle is in, and which position that triangle is in the compression block. The other information includes a mask that indicates, for each triangle, whether that triangle is at the end of a compression block.

Using this information, given an input of the index of a triangle within the set of compression blocks, the decompressor performs bookkeeping operations to calculate which compressed block the triangle is in and which slot in that compressed block stores the information for that triangle. Additional details are provided below.

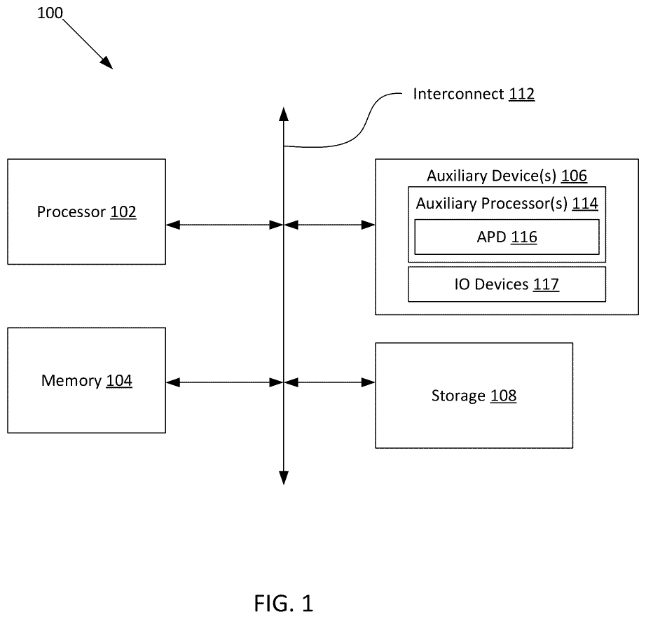

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

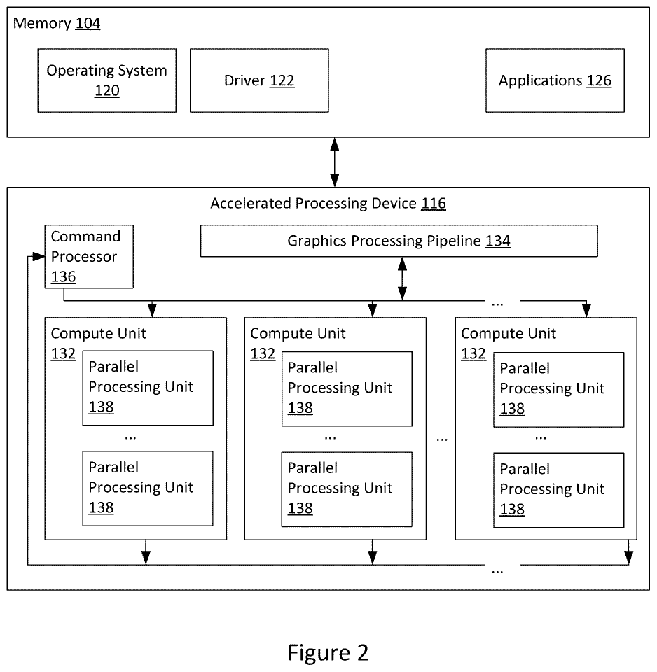

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen, thirty-two or sixty-four lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A command processor 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

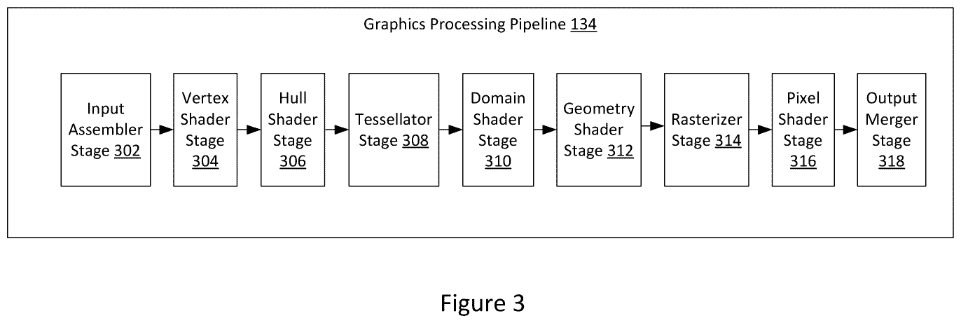

FIG. 3 is a block diagram showing additional details of the graphics processing pipeline 134 illustrated in FIG. 2. The graphics processing pipeline 134 includes logical stages that each performs specific functionality. The stages represent subdivisions of functionality of the graphics processing pipeline 134. Each stage is implemented partially or fully as shader programs executing in the programmable processing units 138, or partially or fully as fixed-function, non-programmable hardware external to the programmable processing units 138.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

The rasterizer stage 314 accepts and rasterizes simple primitives and generated upstream. Rasterization includes determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

It is sometimes advantageous to use a geometry compression scheme. This scheme can reduce the amount of space occupied in memory, and/or can reduce the amount of data that needs to be transferred between memory and processing components (e.g., when the APD 116 loads geometry data from memory 104 for processing). However, compression schemes add additional processing as compared with using an uncompressed format.

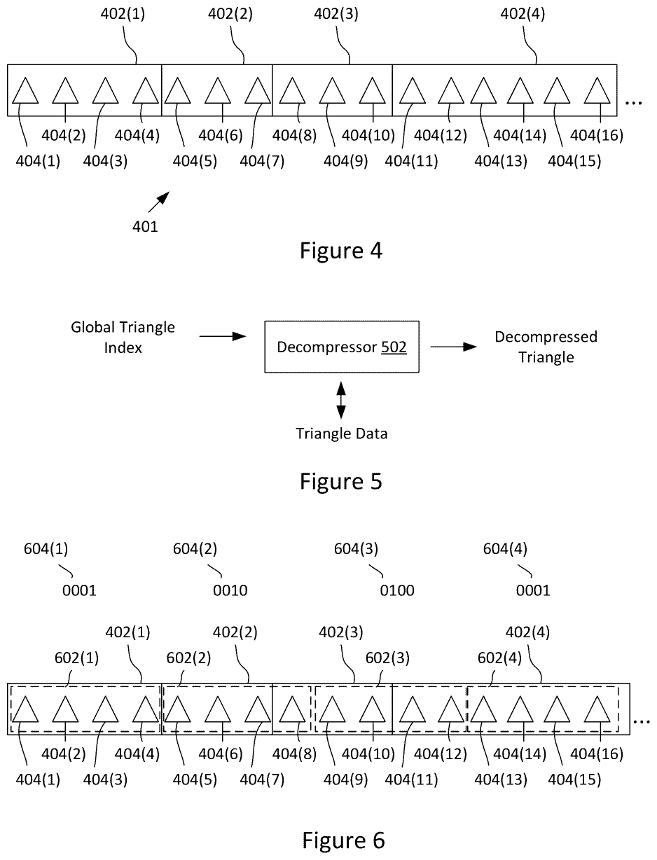

In some compression schemes, one aspect of such processing includes locating a particular element of data within a larger set of compressed data. FIG. 4 illustrates an example of such a compression scheme. In particular, in FIG. 4, a set of compressed data 401 is shown. The set 401 includes a plurality of compression blocks 402. In some examples, the set 401 is a group of geometric data that is compressed together. In an example, the set 401 is a mesh or a part of a mesh that is compressed. Each compression block 402 includes a variable number of compressed data elements 404. In the example shown, these compressed data elements 404 are triangles, though it should be understood that the compression scheme would work with other compressed data elements. It should be understood that, for any description herein that refers to “triangles,” for example in conjunction with element 404 (e.g., as “triangles 404”), the term “triangles” can be replaced with the more general “compressed data element,” which refers to triangles or other types of data that can be compressed together. In some examples, each compression block 402 has the same size. In other words, each compression block 402 is a fixed size block of data that is compressed together, where the “fixed size” is an amount of data that is the same for each compression block 402. In some examples, there are multiple sizes of compression blocks 402 such that many, but not all of the compression blocks 402 of a compressed data set 401 have the same size.

When working with such a compression scheme, it is useful to be able to locate a particular triangle 404 given an index of that triangle, where “locate” means to find which compressed block 402 the triangle 404 is in and which triangle 404 in that compressed block 402 is the requested triangle. In particular, the triangle index that is used is a global index that counts up from the first triangle in the first compressed block 402 to the last triangle in the last compressed block 402 in a set 401. The term “global index” is in contrast with a “local index” that identifies one triangle 404 within a particular compression block 402. In other words, given a particular global triangle index, it is useful to be able to obtain an identifier for a compressed block 402 that contains the triangle as well as the local index for the triangle 404 that specifies which triangle within that compressed block 402 corresponds to the global triangle index. This information is not necessarily straightforward to obtain, as the amount of data occupied by each triangle 404 is variable and thus there is a variable number of triangles 404 in each compressed block 402. In a naive technique, a lookup table is used that stores the compressed block 402 index and the local triangle index for each global triangle index. However, this technique is expensive in terms of the amount of metadata required for storing such lookup table. For this reason, a different technique is provided herein that uses a relatively limited amount of metadata as compared with a full lookup table.

FIG. 5 illustrates a decompression system according to an example. The decompression system includes a decompressor 502. In some examples, the decompressor 502 is software executing on a processor such as the processor 102 or the APD 116, or a combination thereof, or is hardware configured to perform the operations described herein, or is a combination of software and hardware. “Hardware” means circuitry (e.g., digital circuitry) configured to perform the operations described herein.

The global triangle index is a unique identifier for one triangle in the set of compressed data 401. The triangle data includes a set of compressed data 401 as well as metadata that assists with correlating the global triangle index to a compressed block 402 index and a local triangle 404 index. The decompressor 502 converts the global triangle index to a compressed block 402 index and a local triangle 404 index based on the metadata of the triangle data. The decompressor 502 uses these values to read the compressed data for the triangle 404 in the triangle data and decompresses that compressed triangle to produce a decompressed triangle. A specific technique is described for converting the global triangle index to the local triangle index and compressed block 402 index.

As described, metadata is used to perform this conversion. FIG. 6 illustrates information included in the metadata. This metadata is based on the concept of fixed-sized triangle groups 602. In particular, the set of compressed data 401 is divided into fixed-sized triangle groups 602. In FIG. 6, the size of these groups 602 is 4 triangles. For each such group 602, the metadata includes: location information for the first triangle of that group, wherein the location information includes, for that triangle, the compressed block 402 index and the local triangle index in that compressed block, and the metadata also includes a mask 604. The term “base compressed block index” means the compressed block index of that first triangle and the “base local triangle index” means the local triangle index for that first triangle. The mask includes a value for each triangle 404 in the corresponding group 602. The value indicates whether that triangle is at the end of a compressed block 402. In the example shown, the first compressed block 402 is aligned with the first group 602 and thus the last value in the mask 604(1) for the first group 602 is a “1,” indicating that the last element in that group 602 is at the end of the compressed block 402. The rest of the values in the mask 604 are 0. For the second mask 604(2), which corresponds to the second group 602, the third value in that mask 604(2) is a “1,” since the third triangle 404 in the second group 602 is at the end of a compressed block 402 (specifically, triangle 404(7) is at the end of compressed block 402(2)). As can be seen, the other triangles (first, second, and fourth) are not at the end of a compressed block 402 and thus the corresponding value in the mask 604(2) is “0.” Regarding the third group 602, the mask 604(3) indicates that the second triangle in that group 602 (specifically, triangle 404(10)) is at the end of a compressed block 402 and for the fourth group 602, the mask 604(4) indicates that the fourth triangle in that group 602 is at the end of a compressed block 402.

The decompressor 502 uses this metadata (the masks 604 and the information about the location of the beginning of each group 602) to obtain the block 402 index and the local triangle index 404 based on an input global triangle index. A technique for performing this operation is now provided.

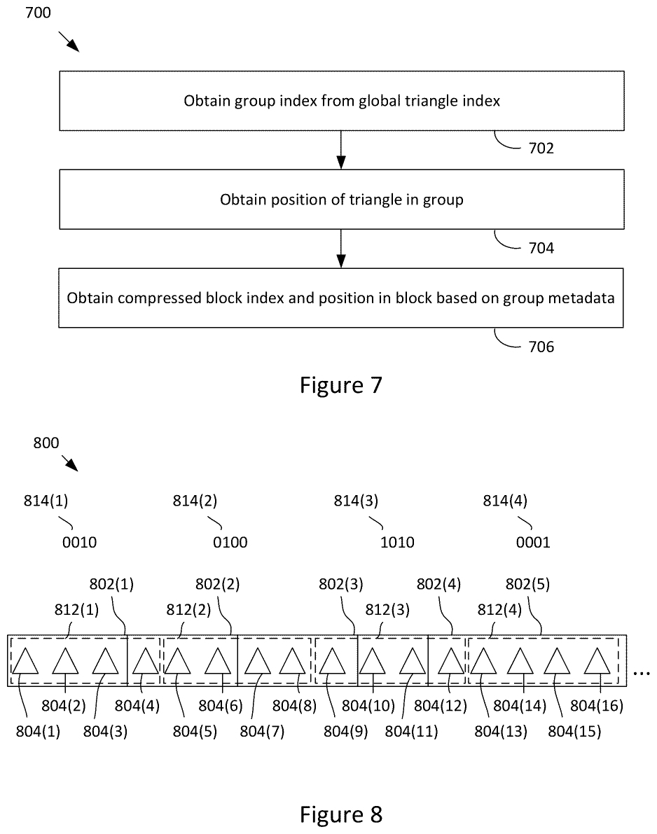

FIG. 7 is a flow diagram of a method for obtaining the block 402 index and local triangle 404 index based on the metadata and the input global triangle index, according to an example. Again, the “block index” is the unique identifier for the compressed block 402 and the local triangle 404 index is a unique identifier for the triangle within that block that corresponds to the global triangle index. Although described with respect to the system of FIGS. 1-6, those of skill in the art will understand that any system configured to perform the steps of the method 700 in any technically feasible order falls within the scope of the present disclosure.

At step 702, the decompressor 502 obtains a group index for the group 602 associated with the input global triangle index. In one example, the decompressor 502 performs this step by dividing the global triangle index by the fixed size of the group 602, and extracting the integer portion of the result. In an example, if the groups have 4 elements and the global triangle index is 7, then the group index is the integer part of 7 divided by 4, which is 1 (as 7/4 is 1.75). Thus, the group index for global triangle index 7 is 1.

At step 704, the decompressor 502 obtains an index within the group corresponding to the global triangle index. This index within the group (or “group triangle index”) is the position within the group 602 of the triangle. In the example of FIG. 6, for triangle 404(8) (which has global triangle index of 7, since indices start at 0), the group index is 1 (because the 0^{th} group is 602(1) and the “1^{st}” group is 602(2)), and the index within the group is 3, because it is the fourth triangle in the group 602. Note that in this example (and many other examples herein), indices start at 0. In an example, the decompressor 502 obtains the index within the group by performing a modulo operation (represented with a percent sign “%”) with the global triangle index and the fixed size of the groups. More particularly, this operation is performed as t_{index} % size_{group}, where t_{index} is the global triangle index and size_{group} is the size of the groups 602. In the example described, this result would be 7% 4=3.

At step 706, the decompressor 502 obtains a compressed block index (sometimes also just “block index”) and a position in the compressed block (e.g., local triangle index) based on the group metadata. In particular, the metadata includes the mask 604 for the group 602 as well as the other metadata for the group indicating the block index and position in block for the first triangle of the group 602. The decompressor 502 determines the block index and position in the compressed block based on this metadata.

The decompressor 502 determines the block index in the following manner. As described above, the mask for the group indicates which triangle(s) in the group is at the end of a compressed block 402. More particularly, the mask includes an indicator for each triangle that provides such an indication. Within the group 602, an indicator means that there is an increment of the compressed block index. In other words, when there is a triangle in a group that is at the end of a compressed block, the next triangle in the group is in the next compressed block 402. In the example of FIG. 6, triangle 404(7) is in group 602(2) and is at the end of compressed block 402(2). This means that the next triangle in the group 602(2) (triangle 404(8)) is in the next compressed block 402(3). For this reason, the decompressor 502 obtains the index of a compressed block 402 for a triangle in a group 602 by adding an increment to the index of the compressed block index of the triangle at the start of a group 602 (this index is included in the metadata for the group 602). This increment is the number of “next block” indicators in the mask for the group 602, prior to the position of the triangle at issue.

In one example using the information of FIG. 6, the decompressor 502 seeks to find the block index for triangle 404(11). The decompressor 502 determines the group index for the triangle 404(11) by dividing the 0-indexed global index for the triangle (10) by the group size (4) to obtain the group index (2). This refers to group 602(3). The corresponding mask 604(3) has value 0100. Further, the metadata for group 602(3) indicates that for the first triangle of that group, this triangle is in block 402(3) (which has 0-starting index of 2) and is the second triangle in that block. For triangle 404(11) (having a zero-starting index of 10), the index in the group is 10% 4=2. The number of “next block” indicators before this index in mask 604(3) is 1, and this is the increment added to the block index. Thus, the zero-starting block index for triangle 404(11) is 2+1=3.

The decompressor 502 also uses this metadata information to obtain the local index of the triangle within the compressed block. To do this, the decompressor 502 takes advantage of the fact that a “next block” indicator acts as a “reset” to the index in the current block. In other words, if a “next block” indicator occurs, then the next triangle after that indicator must be the 0^{th} triangle in this next block. For example, in FIG. 6, triangle 404(11) is immediately after a next block indicator (for triangle 404(10)). Thus, the triangle after this indicator—triangle 404(11)—has an index in this next block of 0, as it is at the start of that block. For this reason, if there are any “next block” indicators in the mask 604 prior to that triangle's indicator, then the decompressor 504 determines the local index for the triangle as the number of indicators past the last next block indicator before the triangle's indicator, minus 1 (or stated differently, the local index for the triangle starts at 0 after a next block indicator and is incremented from there). In the example, for triangle 404(12), the last next-block indicator is for triangle 404(10). Triangle 404(12) is two triangles after this next-block indicator, so the local index for that triangle is the number of indicators past this next-block indicator—two—minus 1, resulting in an index of 1 (again, this is a zero-starting index).

In an example, the decompressor 502 performs the operation to determine the local triangle index in the following manner. First, the decompressor 502 obtains the index within the group 602 for the triangle. Then, the decompressor 502 clears the indicators at and above that index within the mask 604. For example, if the triangle has an index within a group of 2 (indicating that the triangle is the third triangle in the group 602), then the decompressor 502 sets the indicators at that group index and above that group index, within the mask, to not be “next block indicators.” (In examples where “next block” is indicated with a “1,” the decompressor 502 sets these values to a “0,” indicating “not a next block.”). Thus, in a mask having four elements, the third and fourth element would be set to 0. Then, the decompressor 502 determines the index of the highest “next-block indicator” remaining after the others are cleared (or zeroed out). Then the decompressor 502 determines the highest index of a next block indicator (so if both the first and second indicators were “next block indicators,” the highest index would correspond to the second indicator). Then the decompressor 502 takes the index of the triangle in its group 602, subtracts the highest index of a next block indicator, and then subtracts 1 from the result to obtain a position of the triangle in its block. The decompressor 502 performs the above operation if the zeroed-out mask has any “next block indicators.” If there are no such indicators in the mask, then the decompressor 502 instead adds the index of the triangle in its group 602 to the position, for the group, of the lowest triangle in that group within its block. In other words, if there are no next block indicators up to the triangle at issue, this means that the first triangle in the group 602 has the local index specified in the metadata (e.g., the local index of the first triangle in that group 602, within its compressed block 402). A triangle other than the this first triangle, for which no “next block” transition occurs, therefore has a local index equal to the index specified in the metadata plus the index of that triangle within its group 602.

FIG. 8 illustrates an example technique for obtaining a compressed block index and position in the compressed block based on group metadata. This technique is an example of step 706 of FIG. 7.

A set of triangle information 800 is illustrated. This set 800 includes compressed triangles 804 (which are similar to triangles 404), compressed blocks 802 (which are similar to blocks 402), fixed-size groups 812 (similar to groups 602), and masks 814 (similar to masks 604).

An example operation is described to obtain a compressed block index and position in the compressed block based on group metadata for triangle 804(12). This triangle has zero-starting index of 11. This means that the group index is 11/4=2, and the position within the group is 11% 4=3. Thus the corresponding group 812 is group 812(3) and the triangle is the fourth triangle within the group. Also, the mask 814 for that group 812 is mask 814(3), having value 1010 (as the first and third triangles are at the end of a block 802). The decompressor 502 obtains this mask 814 and also obtains the other metadata, indicating, for the first triangle of the group 812, which block 802 that triangle is in as well as which index in that block 802 that first triangle is in.

The decompressor 502 clears the indicators in the mask 814 at and above the triangle being analyzed (e.g., triangle 804(12)). In this case, the mask remains the same, as 1010, since the indicator at the triangle being analyzed is already 0, and there are no indicators after that. Then, the decompressor 502 counts the remaining next-block indicators—two in this instance. To obtain the block index, this number is added to the value indicating which block 802 the first triangle of the group is in. In this case, that block is block 802(3), which has block index 2. Thus, the value of 2 is added to 2, indicating index 4, which corresponds to block 802(5) (which is where triangle 804(12) is). Subsequently, since there is at least one “next block” indicator remaining in the mask, the decompressor 502 determines the index in the block for the triangle in the following manner. The decompressor 502 obtains the position of the highest next-block indicator, which has index 2. Then, the decompressor 502 subtracts this value from the position of the triangle within the group, which is 3, resulting in a value of 1. Then, the decompressor 502 subtracts 1 from this value, resulting in a value of 0. This value is the local index of the triangle within the compressed block. Thus the result is that the triangle of 804(12) is in compressed block having index 4 (block 802(5)) and having local index of 0.

For efficiency, some of the operations described above can be performed with bitwise operations. In particular, the operation to count the number of “1” bits in a value can be performed with a population count instruction. The operation to obtain the highest “1” can also be performed using an instruction to count the number of trailing zeroes (i.e., zeroes on the right or higher side of the mask). The operation to mask out the “next block” indicators at or above a particular triangle index is performed with a bitwise AND operation with a mask having 1's up to the index of the triangle at issue (e.g., to mask out values 3 and 4, mask 1100 is used (note that in the convention used in this patent application, bits on the left-most side of a mask are the lowest numbered bits and bits on the right-most side are the highest numbered bits, so that values 3 and 4 correspond to the 0's in the mask 1100)).

Once the above values are obtained, it is possible to perform decompression. In particular, the value that are obtained include an indication of which compressed block corresponds to the triangle and which position in that compressed block corresponds to the triangle. The decompressor 502 reads the corresponding value in any technically feasible means. In one example, there is a lookup table that correlates compressed block indices to addresses, and there is a lookup table that correlates local indices to an offset within a compressed block. Any other information that indicates such correlations can be used alternatively.

Once the compressed data for a triangle is obtained, decompression involves reversing the compression applied in any technically feasible manner. In one example, the compression scheme is a format called dense geometry format. In this format, each set of geometry data (such as set 401) has an implicit geometry. This implicit geometry indicates how to interpret triangle data. In particular, in a common uncompressed representation of geometry, triangles are represented by two sets of data: vertex indices and unique vertex information. Each triangle has a set of three vertex indices. Each index points to a specific unique vertex in a vertex buffer that stores the vertex information. Indices are used to define triangles in order to eliminate duplication of vertex information. For example, if two triangles share a vertex, including that vertex twice would be wasteful. Thus, each individual triangle is defined by three indices. In dense geometry format, each triangle has a corresponding set of one or more indices. Specifically, it is possible for each triangle to be connected to a previous triangle, in which an edge is shared with that triangle. In this instance, only one new index is stored for the new triangle. However, if the new triangle does not share an edge with any previous triangle, then three indices are stored for that triangle. In addition, on a per triangle basis, additional control information may be stored such as whether the triangle shares an edge with another previous triangle, as well as which edge is shared if there is a shared edge.

In some examples, once a triangle is decompressed, the triangle is rendered. In an example, such a triangle is processed through the graphics processing pipeline 134 of FIG. 3, or is rendered in any other technically feasible manner. In some examples, “rendering” means converting the triangles to one or more pixels that are stored in an image and/or sent to an output device for display.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the auxiliary devices 106, the accelerated processing device 116, IO devices 117, the command processor 136, the graphics processing pipeline 134, the compute units 132, the parallel processing units 138, each element of the graphics processing pipeline 134 (e.g., input assembler stage 302, vertex shader stage 304, hull shader stage 306, tessellator stage 308, domain shader stage 310, geometry shader stage 312, rasterizer stage 314, pixel shader stage 316, or output merger stage 318), or the decompressor 502 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing geometry data comprising:
obtaining a global triangle index for a triangle;
retrieving metadata for the triangle based on a group index and a group triangle index for the global triangle index; and
accessing a compressed block using a compressed block index and a block local index that are based on the group index, the group triangle index, and the metadata.

2. The method of claim 1, wherein the global triangle index indicates a position of the triangle in a set of data including multiple compressed blocks.

3. The method of claim 2, wherein the set of data includes triangles specified via topology metadata that indicates implied vertex indices.

4. The method of claim 1, further comprising:
identifying the group index by dividing the global triangle index by a fixed group size; and
identifying the group triangle index by performing a modulo operation on the global triangle index and the fixed group size.

5. The method of claim 1, wherein the metadata includes, for each group of a set of groups, a next-block mask and an indication, for a first triangle of the group, a base compressed block index and a base local triangle index.

6. The method of claim 5, further comprising wherein identifying the compressed block index by adding a value based on the next-block mask to the base compressed block index.

7. The method of claim 6, wherein the value is equal to a number of next-block indicators before the triangle in the group.

8. The method of claim 5, further comprising identifying the block local index by adding the base local triangle index to the group triangle index.

9. The method of claim 5, further comprising identifying the block local index by adding an offset based on the next-block mask to the base local triangle index.

10. A system comprising:
a memory configured to store metadata for a triangle; and
a processor configured to perform operations including:
obtaining a global triangle index for a triangle;
retrieving metadata for the triangle based on a group index and a group triangle index for the global triangle index; and
accessing a compressed block using a compressed block index and a block local index that are based on the group index, the group triangle index, and the metadata.

11. The system of claim 10, wherein the global triangle index indicates a position of the triangle in a set of data including multiple compressed blocks.

12. The system of claim 11, wherein the set of data includes triangles specified via topology metadata that indicates implied vertex indices.

13. The system of claim 10, wherein the processor is further configured to identify the group index by dividing the global triangle index by a fixed group size and identify the group triangle index by performing a modulo operation on the global triangle index and the fixed group size.

14. The system of claim 10, wherein the metadata includes, for each group of a set of groups, a next-block mask and an indication, for a first triangle of the group, a base compressed block index and a base local triangle index.

15. The system of claim 14, wherein the processor is further configured to identify the compressed block index by adding a value based on the next-block mask to the base compressed block index.

16. The system of claim 15, wherein the value is equal to a number of next-block indicators before the triangle in the group.

17. The system of claim 14, wherein the processor is further configured to identify the block local index by adding the base local triangle index to the group triangle index.

18. The system of claim 14, wherein the processor is further configured to identify the block local index by adding an offset based on the next-block mask to the base local triangle index.

19. A non-transitory computer-readable medium storing instructions that, when executed by a processor, cause the processor to perform operations comprising:
obtaining a global triangle index for a triangle;
retrieving metadata for the triangle based on a group index and a group triangle index for the global triangle index; and
accessing a compressed block using a compressed block index and a block local index that are based on the group index, the group triangle index, and the metadata.

20. The non-transitory computer-readable medium of claim 19, wherein the global triangle index indicates a position of the triangle in a set of data including multiple compressed blocks.
